(19) United States
(12) Patent Application Publication
(10) Pub. No.: US 2012/0278000 A1
(43) Pub. Date: Nov. 1, 2012

(54) METHOD FOR ASSESSING EFFICACY OF COMBINATION CHEMOTHERAPY, AND PROGRAM AND DEVICE FOR ASSESSING THE SAME

(75) Inventors: Chihiro SUMINAKA, Kobe-shi (JP); Amame HARADA, Kobe-shi (JP); Tomoko OHYAMA, Akashi-shi (JP); Yasuhiro TORIKOSHI, Toyonaka-shi (JP)

(73) Assignee: SYSMEX CORPORATION, Kobe-shi (JP)

(21) Appl. No.: 13/457,081

(22) Filed: Apr. 26, 2012

(30) Foreign Application Priority Data
Apr. 27, 2011 (JP) 2011-100184

(51) Int. Cl. G06F 19/00

(52) U.S. Cl. 702/19

(57) ABSTRACT

A method for assessing an efficacy of combination chemotherapy, comprising: a first obtaining process for obtaining a specific activity value of Cyclin Dependent Kinase (CDK) 1 and a specific activity value of CDK2 in a biological sample including a carcinoma cell collected from a cancer patient; a second obtaining process for obtaining a GSTπ expression level in the biological sample; and an assessment process for assessing the efficacy of the combination chemotherapy on the cancer patient based on the specific activity values of CDK1 and CDK2 obtained in the first obtaining process and the GSTπ expression level obtained in the second obtaining process.

### FIELD OF THE INVENTION

The present invention relates to a method for assessing an efficacy of combination chemotherapy, and a program and a device used to assess the efficacy of combination chemotherapy.

### BACKGROUND OF THE INVENTION

A conventional therapeutic method for the treatment of cancers is chemotherapy, wherein various types of carcinostatics are administered to patients. In recent years, combination chemotherapy, in which two or more carcinostatics are combined to take full advantage of their different therapeutic effects, is increasingly employed. The combination chemotherapy is now providing treatment options for progressive cancers that cannot be treated surgically. However, the efficacy of such a beneficial combination chemotherapy is known to be different depending on types of cancers and individual variability of patients. If an inefficacious carcinostatic or an unsuitable combination of carcinostatics is wrongly administered to a patient due to misjudgment in the selection of carcinostatics, not only the risk of recurrence of cancer possibly increases but also the patient is likely to lose or deteriorate his/her physical fitness. In that case, an expected efficacy may not be obtained although any other carcinostatics potentially efficacious is administered afterwards. To avoid such an unfavorable event, it is desirable to develop a system that enables any efficacious carcinostatic or a suitable combination of carcinostatics for combination chemotherapy to be correctly identified for each individual patient before they are administered.

Conventionally, in order to select carcinostatics for the treatment of cancers, carcinoma cells isolated from a patient are brought into contact with different carcinostatics to identify carcinostatics having a therapeutic efficacy for the carcinoma cells by monitoring a degree of growth inhibition of the carcinoma cells. In such a conventional approach involving trials and errors, the reproducibility of test results is often incomplete, failing to reflect the test results on effects of clinical treatment. Further, the assessment of susceptibility described earlier needs a large number of carcinoma cells, imposing a large physical burden on patients. Under the circumstances, it is a vital issue to build a system configured to assess beforehand an efficacy of combination chemotherapy in which carcinostatics are used.

A technical approach for the purpose is a conventional method wherein an efficacy of combination chemotherapy for breast cancer patients is assessed based on an expression level of glutathione S-transferase π (GSTπ) considered to participate in attenuating the toxicity of carcinostatics in cancer tissues (J. Surg. Res., Vol. 113, No. 1, pp. 102-108, 2003). Another example is a conventional method wherein an efficacy of combination chemotherapy on a cancer patient is assessed based on specific activity values of Cyclin Dependent Kinase (CDK) 1 and 2 in malignant tumors collected from the cancer patient (U.S. Patent Application Publication No. 2010/068743).

The present invention provides an assessment method wherein an efficacy of combination chemotherapy to be performed on cancer patients can be more reliably assessed.

### SUMMARY OF THE INVENTION

A first aspect of the present invention is a method for assessing an efficacy of combination chemotherapy, comprising: a first obtaining process for obtaining a specific activity value of Cyclin Dependent Kinase (CDK) 1 and a specific activity value of CDK2 in a biological sample including a carcinoma cell collected from a cancer patient; a second obtaining process for obtaining a GSTπ expression level in the biological sample; and an assessment process for assessing the efficacy of the combination chemotherapy on the cancer patient based on the specific activity values of CDK1 and CDK2 obtained in the first obtaining process and the GSTπ expression level obtained in the second obtaining process.

A second aspect of the present invention is a computer system adapted to assess an efficacy, comprising: a processor; and a memory, under control of said processor, including software instructions adapted to enable the computer system to perform operations comprising: obtaining information of a specific activity value of Cyclin Dependent Kinase (CDK) 1 and a specific activity value of CDK2 in a biological sample including a carcinoma cell collected from a cancer patient; obtaining information of a GSTπ expression level in the biological sample; and assessing the efficacy of the combination chemotherapy on the cancer patient based on the obtained informations of the specific activity values of CDK1 and CDK2 and the obtained information of the GSTπ expression level.

A third aspect of the present invention is an efficacy assessment device, comprising: an obtaining unit for obtaining information of a specific activity value of Cyclin Dependent Kinase (CDK) 1, information of a specific activity value of CDK2, and information of a GSTπ expression level in a biological sample including a carcinoma cell collected from a cancer patient; and an assessment unit for assessing the efficacy of the combination chemotherapy on the cancer patient based on the information of the specific activity value of CDK1, the information of the specific activity value of CDK2, and the information of the GSTπ expression level obtained by the obtaining unit.

### BRIEF DESCRIPTION OF THE DRAWINGS

FIG. 1 is a block diagram schematically illustrating an efficacy assessment system for combination chemotherapy according to a preferred embodiment 2 of the present invention;

FIG. 2 is a flow chart of processes executed by a CPU illustrated in FIG. 1;

FIG. 3 is a ROC curve of pCR prediction subsequent to T-FEC in which a risk score is used;

FIG. 4 is a ROC curve of pCR prediction subsequent to T-FEC in which GSTπ is used; and

FIG. 5 is a ROC curve of pCR prediction subsequent to T-FEC in which the risk score and GSTπ are both used.

### DETAILED DESCRIPTION

### Preferred Embodiment 1

An efficacy assessment method for assessing an efficacy of combination chemotherapy includes: a first obtaining process for obtaining a specific activity value of Cyclin Dependent Kinase (CDK) 1 and a specific activity value of CDK2 in a biological sample including carcinoma cells collected from a cancer patient; a second obtaining process for obtaining an expression level of GSTπ in the biological sample; and an assessment process for assessing the efficacy of the combination chemotherapy on the patient based on the specific activity value of CDK1 and the specific activity value of CDK2 obtained in the first obtaining process, and the expression level of GSTπ obtained in the second obtaining process.

The efficacy assessment method preferably further includes a calculation process for calculating a risk score from the specific activity value of CDK1 and the specific activity value of CDK2 using the formula 1). The respective processes of the method are hereinafter described in detail.

### (First Obtaining Process)

The first obtaining process is a process for obtaining the specific activity value of Cyclin Dependent Kinase (CDK) 1 and the specific activity value of CDK2 in a biological sample including carcinoma cells collected from a cancer patient.

The carcinoma cells subject to the first obtaining process are not particularly limited as far as they are constitutive cells of a malignant tumor. The carcinoma cells can be collected from, for example, breast cancer, lung cancer, stomach cancer, colon cancer, ovarian cancer, brain cancer, prostate cancer, skin cancer, hepatic cancer, gallbladder cancer, pancreatic cancer, and leukemia. Of these examples, carcinoma cells collected from breast cancer, lung cancer, stomach cancer, colon cancer, ovarian cancer, brain cancer, prostate cancer, skin cancer, and leukemia are preferably used. A particularly preferable example is carcinoma cells of breast cancer.

The biological sample is not particularly limited as far as carcinoma cells collected from the cancer patient are included therein. Specific examples of the biological substance are blood, serum, lymphatic fluid, urine, nipple discharge, and cells and tissues collected from a cancer patient during a surgical operation or biopsy. A test sample obtained by culturing cells or tissues collected from a cancer patient may be used as the biological sample.

The CDK1 is a protein which is activated during transition from G2 phase to M phase of a cell cycle. The CDK2 is a protein which is activated during transition from G1 phase to S phase of a cell cycle. Typically, a carcinoma cell is aggressively proliferating beyond normal proliferation control. Therefore, it is a general view that a large percentage of carcinoma cells are in S phase which is a DNA duplication phase and G2 phase which is a phase between the end of DNA synthesis and the start of mitotic division. It is considered that the aneuploidy and polyploidy observed in a carcinoma cell is generated when the cell is in an abnormal state during M phase which is a cell division phase or when skipping M phase and transit to G1 phase and then immediately transits to S phase. Therefore, only a small percentage of carcinoma cells are present in M phase. Thus, the carcinoma cell is often undergoing an abnormality in the control of its cell cycle. Therefore, the expression levels and activity values of CDK1 and CDK2 in charge of controlling the cell cycle are acknowledged as important factors for identifying whether the cell is cancerous.

A ratio of the specific activity values of CDK1 and CDK2 (hereinafter, may be simply referred to as “CDK”) (CDK2 specific activity value/CDK1 specific activity value) can be regarded as a numeral value reflecting how many cells in S phase or G2 phase are present as compared to cells in M phase. The ratio can be used as a parameter which accurately reflects the potency of cell proliferation.

The specific activity values of CDK1 and CDK2 are obtained by dividing the respective CDK activity values in a biological sample including carcinoma cells by the CDK expression levels. The first obtaining process of the efficacy assessment method provided to obtain the specific activity values of CDK1 and CDK2, may further include: a CDK measurement step for measuring the CDK activity values and CDK expression levels; and a specific activity value calculation step for calculating the specific activity values from a measurement result obtained in the CDK measurement step.

The CDK activity value is expressed by, for example, a Kinase-active level (expressed by U (unit)) calculated from a quantity of substrate phosphorylated by the CDK. An example of the substrate phosphorylated by the CDK is histone H1.

The CDK measurement step can measure the CDK activity values using the CDK activity measuring methods conventionally employed. Describing one of the conventional methods in which a radioactive substance is used, a test sample including the CDK is prepared from a lasate of a measurement sample, the test sample and ³²P-labeled adenosine triphosphate (γ-[³²P]-ATP) are used to introduce ³²P into a substrate protein, and a quantity of the ³²P-labeled phosphorylated substrate is measured. US Patent Application No. 2002/0164673 discloses an example of the methods in which no radioactive substance is used. Describing the method, a test sample including a target CDK is prepared from a lysate of an analyte, adenosine 5′-O-(3-thiotriphosphate) (ATP-γS) and a substrate protein are reacted with each other to introduce monothiophosphoric acid groups into serine or threonine residue of the substrate protein, a labeling fluorescent substance or a labeling enzyme is bonded to sulfur atoms of the introduced monothiophosphoric acid groups to label the substrate protein, and a quantity of the thiophosphoric acid substrate thus labeled is measured.

To prepare the test sample including the CDK from the lysate of the measurement sample, for example, the CDK is specifically captured by the use of an anti-CDK antibody from a biological sample lysate containing carcinoma cells to be measured.

The CDK expression level is a quantity of CDK included in the lysate of biological sample containing carcinoma cells to be measured (expressed by a unit corresponding to number of molecules). In the CDK measurement step, the CDK expression level can be measured by any of conventional methods available for measuring a quantity of CDK from the lysate. To measure the CDK expression level, for example, a target CDK is captured by the use of a specific antibody such as an anti-CDK antibody and a quantity of the captured CDK is determined. Specifically, methods such as ELISA, western blotting, and the method disclosed in US Patent Application No. 2004/0214180 are employed.

### (Second Obtaining Process)

The second obtaining process of the efficacy assessment method is a process for obtaining the expression level of GSTπ.

The GSTπ is a protein having a molecular weight of approximately 22.5 kDa encoded by GSTP1 gene, which is one of the enzymes belonging to the human Glutathione-S-transferase (GST) family. The GSTπ participates in attenuating the toxicity of a carcinostatic by catalyzing conjugate formation between reduced glutathione (GSH) and the carcinostatic. Therefore, it is generally thought that a carcinoma cell undergoing a high GSTπ expression level has a higher tolerance against carcinostatics than any carcinoma cells in which GSTπ is lowly expressed.

The second obtaining process of the efficacy assessment method may be solely responsible for obtaining the expression level of GSTπ or may further include a GSTπ measurement step for measuring the expression level of GSTπ.

The GSTπ measurement step may measure the expression level of GSTπ in any form as far as the expression levels of, for example, GSTπ protein and mRNA can be thereby measured. Examples of the measurement method are SDS polyacrylamide electrophoresis, two-dimensional electrophoresis, protein chip analysis, enzyme-linked immunosorbent assay (ELISA), immunofluorescence, western blotting, dot blotting, immune precipitation, RT-PCR, northern blotting, NASBA, and DNA chip analysis. Of these examples, western blotting, dot blotting, and ELISA are preferably employed to measure the expression level of GSTπ protein in view of factors such as quantitative accuracy, reproducibility, and easy handleability, and northern blotting is preferably used to measure the expression level of mRNA of GSTπ. Particularly preferable examples are dot blotting and western blotting, which are the methods for measuring the expression level of GSTπ protein, to attain a high accuracy in the assessment method.

### (Calculation Process)

The calculation process calculates a risk score from the specific activity values of CDK1 and CDK2 obtained in the first obtaining process using the formula 1).

In the formula 1), x represents the specific activity value of CDK1. y represents a ratio of the specific activity value of CDK2 to the specific activity value of CDK1.

When the CDK1 specific activity value x is regarded as a first risk element, and the ratio of CDK specific activity values (CDK2 specific activity value/CDK1 specific activity value) y is regarded as a second risk element, a relationship between the first and second risk elements and a risk of inefficacy of combination chemotherapy can be evaluated. Of numerical evaluations of the risk of inefficacy of combination chemotherapy, the evaluation based on the first risk element is expressed by a function F (x), and the evaluation based on the second risk element is expressed by a function G (y). Of numerical evaluations of the risk of inefficacy of combination chemotherapy, the evaluation based on the first and second risk elements is called a risk score. The risk score can be expressed as a product of F (x) and G (y).

It is preferable that F (x) be expressed by the formula 2), and G (y) be expressed by the formula 3). The symbols a to f in the formulas 2) and 3) are constants.

The constants a to c are settled by a relationship between the CDK1 specific activity value and a probability of inefficacy of combination chemotherapy. The constants d to f are settled by a relationship between the CDK2 specific activity value/CDK1 specific activity value and the probability of inefficacy of combination chemotherapy.

### (Assessment Process)

The assessment process according to the present invention is a process for assessing the efficacy of the combination chemotherapy on the cancer patient based on the specific activity values of CDK1 and CDK2 obtained in the first obtaining process and the expression level of GSTπ obtained in the second obtaining process.

The combination chemotherapy is a therapeutic treatment in which two or more carcinostatics are combined and used. There are several regimens of the combination chemotherapy, for example; a combination chemotherapy 1 in which anthracyclines and other carcinostatics are combined, a combination chemotherapy 2 in which taxanes and other carcinostatics are combined, a combination chemotherapy 3 in which anthracyclines and taxanes are combined, and a combination chemotherapy 4 in which any other carcinostatics are combined.

Examples of the combination chemotherapy 1 are AC, FAC, FEC, and EC. An example of the combination chemotherapy 2 is TC. Examples of the combination chemotherapy 3 are TAC, AC-T, FEC-T, and T-FEC. An example of the combination chemotherapy 4 is CMF. A, C, F, E, and T in the categories of combination chemotherapy respectively represent the following carcinostatics.

A: doxorubicin (anthracycline-series)
C: cyclophosphamide
F: fluorouracil
E: epirubicin (anthracycline-series)
T: paclitaxel or docetaxel (taxane-series)

AC-T represents a treatment method in which A and C are administered and T is thereafter administered, and FEC-T represents a treatment method in which F, E, and C are administered and T is thereafter administered. On the contrary, T-FEC represents a treatment method in which T is administered and F, E, and C are thereafter administered. Thus, treatment methods in which different carcinostatics are administered at different times is included in the combination chemotherapy as well as treatment methods in which all of the carcinostatics are administered at once.

The combination chemotherapy is preferably the combination chemotherapy in which anthracycline-series carcinostatics and taxane-series carcinostatics are combined, wherein T-FEC, AC-T, TAC, and FEC-T are preferably employed.

The assessment process preferably compares the risk score to a first threshold, compares the GSTπ expression level to a second threshold, and assesses the efficacy of the combination chemotherapy on the cancer patient based on obtained comparison results.

The assessment process preferably assesses the combination chemotherapy as having a low efficacy on the cancer patient when the risk score is equal to or smaller than the first threshold or the GSTπ expression level is larger than the second threshold.

The first threshold may be values suitably set depending on types of carcinoma cells, types of biological samples, and methods employed to measure the CDK expression level. For example, the first threshold can be calculated from risk scores calculated from expression levels and activity values of CDK1 and CDK2 in biological samples collected from a plurality of cancer patients, and efficacies of the combination chemotherapy on the respective patients, for example, whether pathological complete response (pCR) is achieved or not. The threshold can be calculated from these data by the receiver operating characteristic (ROC) analysis, median calculation, calculation of average value±standard deviation, or the like. When the risk score calculated from the expression levels and activity values of CDK1 and CDK2 in a biological sample of a cancer patient is equal to or smaller than the threshold, the combination chemotherapy is assessed as having a low efficacy on the cancer patient. When the risk score is larger than the threshold, it is not possible to define a certain tendency of the efficacy of the combination chemotherapy on the cancer patient. Describing that the combination chemotherapy exhibits an efficacy on the cancer patient, it means that tumors disappear in consequence of the combination chemotherapy such as T-FEC. To determine whether the combination chemotherapy is efficacious, there needs to be an acceptance standard suitably defined for each type of cancers.

The second threshold may be values suitably set depending on types of carcinoma cells, types of biological samples, and methods employed to measure the GSTπ expression level. For example, the second threshold can be calculated from GSTπ expression levels in biological samples collected from a plurality of cancer patients, and efficacies of the combination chemotherapy on the respective patients, for example, whether pathological complete response (pCR) is achieved or not. The threshold can be calculated from these data similarly to the calculation of the first threshold. When the GSTπ expression level in a biological sample is larger than the threshold, the combination chemotherapy is assessed as having a low efficacy. When the GSTπ expression level is equal to or smaller than the threshold, it is not possible to define a certain tendency of the efficacy of the combination chemotherapy on the cancer patient.

When the risk score and the GSTπ expression level are combined and used as an index for assessing the efficacy of the combination chemotherapy, the assessment is more reliable than independently using the risk score and the GSTπ expression level. Particularly, a negative predictive value (NPV) can be more accurate. The reliability of the efficacy assessment can be evaluated from P-value. The P-value is smaller as the reliability is higher, and the P-value is larger as the reliability is smaller. It is very useful for pCR prediction subsequent to the combination chemotherapy such as T-FEC to use the risk score and the GSTπ expression level both as an index for assessing the efficacy of the combination chemotherapy.

### Preferred Embodiment 2

### Efficacy Assessment Program

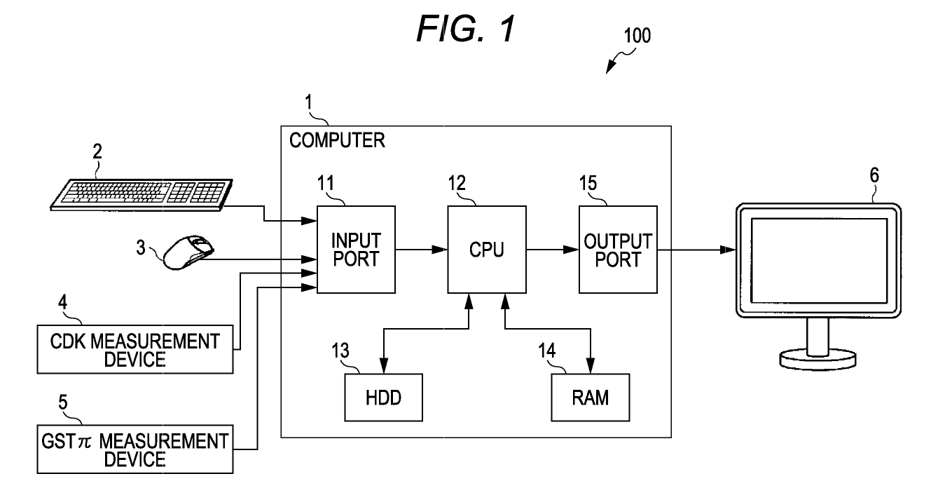

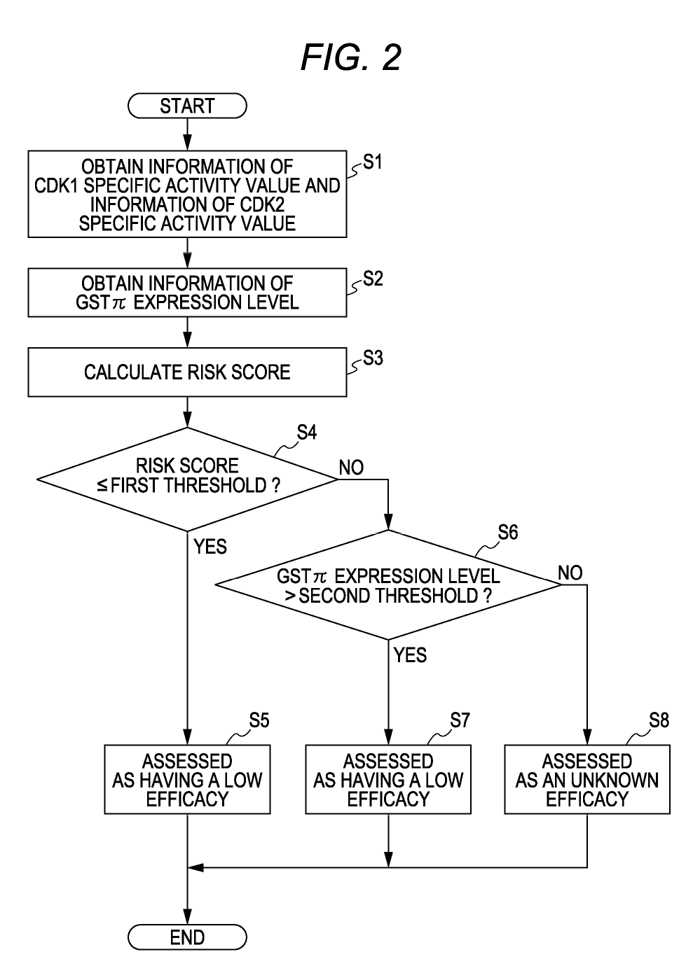

FIGS. 1 and 2 show a computer configured to assess the efficacy of the combination chemotherapy according to the preferred embodiment 1. First, a system 100 illustrated in FIG. 1 is described. The system 100 illustrated in FIG. 1 has a computer 1, a keyboard 2, a mouse 3, a CDK measurement device 4, a GSTπ measurement device 5, and a display device 6. The computer 1 is connected to the keyboard 2, mouse 3, CDK measurement device 4, GSTπ measurement device 5, and display device 6, respectively, by means of communication cables.

The computer 1 is configured to obtain information of the CDK1 specific activity value and CDK2 specific activity value in a biological sample including carcinoma cells which is collected from a cancer patient and further obtain information of the GSTπ expression level in the biological sample, and then assess the efficacy of the combination chemotherapy on the cancer patient based on the obtained informations. The configuration of the computer 1 will be described in detail later. The keyboard 2 and the mouse 3 are devices used by a user, such as a doctor, to input the informations to the computer 1.

The CDK measurement device 4 is configured to measure the CDK1 activity value and expression level in a biological sample including carcinoma cells which is collected from a cancer patient. The CDK measurement device 4 further measures the CDK2 activity value and expression level in the biological sample. The CDK measurement device 4 may be further configured to divide the measured CDK activity values by the CDK expression levels to calculate the CDK specific activity values. The CDK measurement device 4 inputs the information relating to the CDK1 specific activity value (CDK1 activity value and expression level or CDK1 specific activity value) and the information relating to the CDK2 specific activity value (CDK2 activity value and expression level or CDK2 specific activity value) to the computer 1. The GSTπ measurement device 5 is configured to measure the GSTπ expression level in the biological sample and input a measurement result thereby obtained to the computer 1 as information of the GSTπ expression level. The display device 6 receives from the computer 1 an assessment result computed by the computer 1 and displays thereon the received assessment result.

Next, the configuration of the computer 1 is described. The computer 1 has an input port 11, a CPU 12, an HDD 13, a RAM 14, and an output port 15. The input port 11 is connected to the keyboard 2, mouse 3, CDK measurement device 4, and GSTπ measurement device 5, respectively, by means of communication cables. The input port 11 is an interface through which the CPU 12 obtains the information relating to the CDK1 specific activity value, the information relating to the CDK2 specific activity value, and the information of the GSTπ expression level from any of the keyboard 2, mouse 3, CDK measurement device 4, and GSTπ measurement device 5.

The CPU 12 is connected to the input port 11, HDD 13, RAM 14, and output port 15, respectively, by means of communication buses to execute functions installed in an efficacy assessment program. The HDD 13 stores therein the efficacy assessment program including six functions to be executed by the CPU 12. The six functions are described below.

A first function is to obtain the information of the CDK1 specific activity value and the information of the CDK2 specific activity value in a biological sample including carcinoma cells which is collected from a cancer patient. A second function is to obtain the information of the GSTπ expression level in the biological sample. A third function is to calculate the risk score using the information of the CDK1 specific activity value and the information of the CDK2 specific activity value obtained by the first function and the formula 1) described in the preferred embodiment 1.

A fourth function is to compare the risk score calculated by the third function to the first threshold. A fifth function is to compare the GSTπ expression level known from the information obtained by the second function to the second threshold. A sixth function is to assess the combination chemotherapy as having a low efficacy on the cancer patient when the risk score is equal to or smaller than the first threshold or the GSTπ expression level is larger than the second threshold. The combination chemotherapy is the combination chemotherapy in which anthracyclines and taxanes are combined.

The HDD 13 stores therein the formula 1) and the first and second thresholds. The function F(x) included in the formula 1) is a function expressed by the formula 2) described in the preferred embodiment 1. The function G(y) included in the formula 1) is a function expressed by the formula 3) described in the preferred embodiment 1. The function F(x) includes constants a to c, and the function G(y) includes constants d to f. Therefore, the constants a to f are stored in the HDD 13 as well as the formulas 2) and 3). A variable x in the formula 2) represents the CDK1 specific activity value, and a variable y in the formula 3) represents the CDK2 specific activity value. The formulas 2) and 3) and the first and second thresholds, which were described in detail in the preferred embodiment 1, are not described again.

An operation of the CPU 12 of the computer 1 is hereinafter described referring to FIG. 2. The CPU 12 obtains the information of the CDK1 specific activity value and the information of the CDK2 specific activity value including carcinoma cells which is collected from a cancer patient from the keyboard 2, mouse 3, or CDK measurement device 4 by way of the input port 11 (S1). The CPU 12 may obtain the information of the CDK1 specific activity value and the information of the CDK2 specific activity value by receiving the informations which the user inputted using the keyboard 2 or the mouse 3. The CPU 12 may obtain the information of the CDK1 specific activity value and the information of the CDK2 specific activity value by receiving the informations from the CDK measurement device 4. The CPU 12 stores the obtained informations of the CDK1 specific activity value and CDK2 specific activity value in the RAM 14. When the information of the CDK1 specific activity value inputted from the keyboard 2, mouse 3, or CDK measurement device 4 is the CDK1 activity value and the CDK1 expression level, the CPU 12 divides the CDK1 activity value by the CDK1 expression level to calculate the CDK1 specific activity value. Then, the CPU 12 stores the calculated CDK1 specific activity value in the RAM 14 as the information of the CDK1 specific activity value. When the inputted information of the CDK2 specific activity value is the CDK2 activity value and the CDK2 expression level, the CPU 12 divides the CDK2 activity value by the CDK2 expression level to calculate the CDK2 specific activity value. Then, the CPU 12 stores the calculated CDK2 specific activity value in the RAM 14 as the information of the CDK2 specific activity value.

Next, the CPU 12 obtains the information of the GSTπ expression level in the biological sample including carcinoma cells which is collected from the cancer patient from the keyboard 2, mouse 3, or GSTπ measurement device 5 by way of the input port 11 (S2). The CPU 12 may obtain the information of the GSTπ expression level by receiving the information which the user inputted using the keyboard 2 or the mouse 3 or by receiving the information from the GSTπ measurement device 5. The CPU 12 stores the obtained information of the GSTπ expression level in the RAM 14.

Then, the CPU 12 obtains the information of the CDK1 specific activity value and the information of the CDK2 specific activity value from the RAM 14 and further obtains the formulas 1), 2), and 3) and the constants a to f from the HDD 13. Then, the CPU 12 calculates the risk score using the formulas 1), 2), and 3) where the CDK1 specific activity value is represented by x, and the CDK2 specific activity value is represented by y (S3).

Then, the CPU 12 obtains the first threshold from the HDD 13, and compares the risk score calculated in Step S3 to the obtained first threshold (S4). When a comparison result indicates that the risk score is equal to or smaller than the first threshold (Yes in S4), the CPU 12 assesses the combination chemotherapy as having a low efficacy on the cancer patient (S5).

When the comparison result indicates that the risk score is larger than the first threshold (No in S4), the CPU 12 obtains the information of the GSTπ expression level from the RAM 14 and further obtains the second threshold from the HDD 13 to compare the GSTπ expression level to the second threshold (S6). When a comparison result indicates that the GSTπ expression level is larger than the second threshold (Yes in S6), the CPU 12 assesses the combination chemotherapy as having a low efficacy on the cancer patient (S7). When the comparison result indicates that the GSTπ expression level is equal to or smaller than the second threshold (No in S6), the CPU 12 assesses that whether the combination chemotherapy has a low efficacy on the cancer patient is unknown (S8). The CPU 12 outputs the assessment result to the display device 6 by way of the output port 15. Then, the operation of the CPU 12 ends. The display device 6 receives the assessment result from the output port 15 of the computer 1 and displays the received assessment result thereon.

As described so far, the CPU 12 obtains the information of the CDK1 specific activity value and the information of the CDK2 specific activity value in a biological sample including carcinoma cells which is collected from a cancer patient and also obtains the information of the GSTπ expression level in the biological sample, and calculates the risk score from the CDK1 specific activity value and CDK2 specific activity value. Then, the CPU 12 compares the risk score to the first threshold. When the risk score is equal to or smaller than the first threshold, the CPU 12 assesses the combination chemotherapy as having a low efficacy on the cancer patient. When the GSTπ expression level is larger than the second threshold, the CPU 12 assesses the combination chemotherapy as having a low efficacy on the cancer patient. The display device 6 displays the assessment result thereon. When the computer 1 is thus used, the user can instantly and objectively know whether the combination chemotherapy has a low efficacy on the cancer patient. Therefore, the user can very reliably estimate the therapeutic effectiveness of the combination chemotherapy on the cancer patient.

According to the preferred embodiment 2 described so far, the CPU 12 compares the risk score to the first threshold in Step S4, and when the obtained comparison result indicates that the risk score is larger than the first threshold (No in S4), the CPU 12 compares the GSTπ expression level to the second threshold in Step S6. The CPU 12 may compare the GSTπ expression level to the second threshold before comparing the risk score to the first threshold. In that case, when the obtained comparison result indicates that the GSTπ expression level is equal to or smaller than the second threshold, the CPU 12 may compare the risk score to the first threshold. The CPU 12 may compare the GSTπ expression level to the second threshold and the risk score to the first threshold at substantially the same time. In either case, the CPU 12 assesses the combination chemotherapy as having a low efficacy on the cancer patient when the risk score is equal to or smaller than the first threshold or the GSTπ expression level is larger than the second threshold.

According to the preferred embodiment 2 described so far, the efficacy assessment program including the functions to be executed by the CPU 12 are stored in the HDD 13. The efficacy assessment program may be originally stored in, for example, a transportable recording medium, and then accessed and stored in the HDD 13 or the RAM 14 of the computer 1 to be run by the CPU 12. The embodiment of the efficacy assessment program includes storage of the program in recording mediums, and distribution of the program stored in recording mediums.

According to the preferred embodiment 2 described so far, the CPU 12 calculates the risk score from the CDK1 specific activity value and CDK2 specific activity value. It is unnecessary for the CPU 1 to calculate the risk score as far as the efficacy of the combination chemotherapy on the cancer patient can be assessed based on the CDK1 specific activity value, CDK2 specific activity value, and GSTπ expression level. The CPU 12 may assess the efficacy of the combination chemotherapy on the cancer patient solely based on the CDK1 specific activity value, CDK2 specific activity value, and GSTπ expression level.

According to the preferred embodiment 2 described so far, the function F(x) included in the formula 1) used to calculate the risk score is expressed by the formula 2), and the function G(y) included in the formula 1) is expressed by the formula 3). When the formula 1) is used to calculate the risk score, the functions F(x) and G(y) may be expressed by formulas other than the formulas 2) and 3).

According to the preferred embodiment 2 described so far, the CPU 12 assesses the combination chemotherapy as having a low efficacy on the cancer patient when the risk score is equal to or smaller than the first threshold or the GSTπ expression level is larger than the second threshold. Any methods but the described method can be employed as far as whether the efficacy of the combination chemotherapy on the cancer patient is low can be assessed. The CPU 12 may omit one or both of the comparison of the risk score to the first threshold and the comparison of the GSTπ expression level to the second threshold. The CPU 12 may assess the efficacy of the combination chemotherapy on the cancer patient solely based on the CDK1 specific activity value, CDK2 specific activity value, and GSTπ expression level.

According to the preferred embodiment 2 described so far, the combination chemotherapy is the combination chemotherapy in which anthracyclines and taxanes are combined. However, the combination chemotherapy is not necessarily limited to the combination chemotherapy which uses anthracyclines and taxanes.

According to the preferred embodiment 2 described so far, the CPU 12 passively receives the information of the CDK1 specific activity value and the information of the CDK2 specific activity value in Step S1 illustrated in FIG. 2. The CPU 12 may actively obtain the information by periodically or randomly requesting the CDK measurement device 4 to output these informations. Similarly, the CPU 12 passively obtains the information of the GSTπ expression level in Step S2 illustrated in FIG. 2 according to the preferred embodiment 2. The CPU 12 may actively obtain the information by periodically or randomly requesting the GSTπ measurement device 5 to output the information.

According to the preferred embodiment 2 described so far, the CDK measurement device 4 inputs the information of the CDK1 specific activity value and the information of the CDK2 specific activity value to the computer 1. In place of inputting the information of the CDK1 specific activity value and the information of the CDK2 specific activity value to the computer 1, the CDK measurement device 4 may input the information of the CDK1 activity value and expression level and the information of the CDK2 activity value and expression level to the computer 1. In that case, the CPU 12 receives the information of the CDK1 activity value and expression level and the information of the CDK2 activity value and expression level from the CDK measurement device 4 by way of the input port 11. Then, the CPU 12 divides the CDK1 activity value by the CDK1 expression level to calculate and obtain the CDK1 specific activity value. Similarly, the CPU 12 divides the CDK2 activity value by the CDK2 expression level to calculate and obtain the CDK2 specific activity value. The CPU 12 may actively obtain the information of the CDK1 activity value and expression level and the information of the CDK2 activity value and expression level by periodically or randomly requesting the CDK measurement device 4 to output these informations.

According to the preferred embodiment 2 described so far, the first and second thresholds, formulas 1), 2), and 3), and constants a to c are stored in the HDD 13. These numerical elements may be obtained by the CPU 12 when inputted by the user to the computer 1 using the keyboard 2 or the mouse 3 or inputted by the CDK measurement device 4 or the GSTπ measurement device 5 to the computer 1 and then stored in the HDD 13.

According to the preferred embodiment 2 described so far, the computer 1 is connected to the keyboard 2, mouse 3, CDK measurement device 4, GSTπ measurement device 5, and display device 6, respectively, by means of communication cables. The computer 1 may be wirelessly connected to a part or all of the keyboard 2, mouse 3, CDK measurement device 4, GSTπ measurement device 5, and display device 6.

According to the preferred embodiment 2 described so far, the computer 1 is connected to the display device 6. In place of or in addition to the display device 6, the computer 1 may be connected to, for example, a speaker, a printer, or a mobile communication terminal device. In that case, the user can know whether the efficacy of the combination chemotherapy on the cancer patient is low when the speaker, for example, audibly reports the assessment result.

The carcinoma cell according to the preferred embodiment 2 is a carcinoma cell of, for example, breast cancer, lung cancer, stomach cancer, colon cancer, ovarian cancer, brain cancer, prostatic cancer, skin cancer, hepatic cancer, gallbladder cancer, pancreatic cancer, or leukemia. The biological sample according to the preferred embodiment 2 is a sample including carcinoma cells collected from a cancer patient. For example, the biological sample according to the preferred embodiment 2 is blood, serum, lymphatic fluid, urine, nipple discharge, and cells and tissues collected from a cancer patient during a surgical operation or biopsy. A test sample obtained by culturing cells or tissues collected from a cancer patient may be used as the biological sample.

Hereinafter, the present invention is described in further detail referring to working examples, however, the present invention is not necessarily limited thereto.

### <Measurement of CDK1 and CDK2 Specific Activity Values>

### [Preparation of Measurement Sample]

### (Preparation of Reagent)

### Complete Tablet-Dissolved Solution:

A complete tablet (supplied by Roche) was dissolved in 2 mL of ultrapure water to prepare a complete tablet-dissolved solution.

### Buffer Solution A:

The complete tablet-dissolved solution was introduced to a solution containing the following materials at the mentioned end concentrations: 50 mM of Tris-HCl (pH 7.5), 5 mM of EDTA (pH 8.0), 50 mM of NaF, 1 mM of Na₃VO₄, and 0.1% of NP-40 (supplied by CALBIOCHEM), to be diluted by 25 times to prepare a buffer solution.

### (Preparation of Measurement Sample)

Tumor tissue samples collected from breast cancer patients by a mammotome were suspended in the buffer solution A in a tube. The buffer solution A was introduced: in the amount of 400 μL to tumor tissue samples having a size about 4 mm square, in the amount of 200 μL to tumor tissue samples having a size about 3 mm square, and in the amount of 300 μL to tumor tissue samples having a mid size. The tumor tissue samples were homogenized by an electric homogenizer and comminuted to prepare a cell lysate. The cell lysate was centrifuged at 4° C. and 15,000 rpm for five minutes, and a supernatant liquid thereby obtained was used as the measurement sample. The tumor tissue samples collected from the breast cancer patients were 112 analytes in total.

### [Measurement of CDK1 and CDK2 Expression Levels]

### (Preparation of Reagent and Standard Preparation)

### Tris-Buffer Physiological Salt Solution (TBS):

10×TBS (solution containing the following materials at the mentioned end concentrations: 250 mM of 2-Amino-2-hydroxymethyl-1,3-propanediol, 0.1% of NaN₃ (w/v), and 1.5 M of NaCl and having the pH adjusted to 7.4 by HCl) was diluted by 10 times to prepare TBS.

### Blocking Reagent:

The following materials were dissolved in the TBS at the mentioned end concentrations: 4% of bovine serum albumin (BSA, w/v) (supplied by Proliant Health & Biologicals) and 0.1% of NaN₃ (w/v) to prepare a blocking reagent.

### Primary Antibody Reagent:

The following materials were dissolved in ultrapure water at the mentioned end concentrations: 3.2% of Block Ace Powder (w/v) (supplied by Dainippon Sumitomo Pharma Co., Ltd.) and 0.1% of NaN₃ (w/v) to prepare a solution. Then, an anti-CDK1 antibody 1 was dissolved in the prepared solution so that to be contained in the amount of 12 μg/mL to prepare an anti-CDK1 antibody reagent. Similarly, an anti-CDK2 antibody was dissolved in the solution to be contained in the amount of 7.5 μg/mL in place of the anti-CDK1 antibody to prepare an anti-CDK2 antibody reagent.

### Secondary Antibody Reagent:

The following materials were dissolved in the TBS at the mentioned end concentrations: 1% of BSA (w/v) and 0.1% of NaN₃ (w/v) to prepare a solution. Then, a biotinylated anti-rabbit IgG antibody (supplied by Southern Biotech) was dissolved in the prepared solution to be contained in the amount of 8 μg/mL to prepare a secondary antibody reagent.

### Fluorescence-Labeled Reagent:

The following materials were dissolved in the TBS at the mentioned end concentrations: 1% of BSA (w/v) and 0.1% of NaN₃ (w/v) to prepare a solution. Then, Fluorescein-StreptAvidin (supplied by Vector Laboratories) was dissolved in the prepared solution to be contained in the amount of 10 μg/mL to prepare a fluorescence-labeled reagent.

### Fluorescence-Enhancing Reagent:

A fluorescence-enhancing reagent was prepared. The reagent included the following materials at the mentioned end concentrations: 100 mM of 3-Morpholinopropanesulfonic acid and 0.1% of NaN₃ (w/v) and had the pH adjusted to 7.9 by NaOH.

### CDK Standard Diluent for Expression Level:

The following materials were dissolved in the TBS at the mentioned end concentrations: 876.4 mM of Sucrose, 0.005% of BSA (w/v), 0.005% of NP40, and 0.1% of NaN₃ (w/v) to prepare a CDK standard preparation buffer solution for expression level.

### Standard Preparation for Measuring BG of CDK1/2 Expression Level:

The following materials were dissolved in the TBS at the mentioned end concentrations: 0.005% of BSA (w/v), 0.005% of NP40, and 0.1% of NaN₃ (w/v) to prepare a standard preparation for measuring CDK1/2 expression level BG.

### Standard Preparation for Measuring CDK1 Expression Level:

CDK1/cyclin B1, active (supplied by Millipore) was introduced to the CDK standard dilution buffer for expression level and diluted to be contained in the amount of 10 μg/mL. 3 mL of the diluted solution was introduced to 95 mL of the CDK standard preparation buffer solution for expression level to prepare a standard preparation for measuring CDK1 expression level.

### Standard Preparation for Measuring CDK2 Expression Level:

cdk2 (supplied by Santa Cruz) was introduced to the CDK standard dilution buffer for expression level for diluting to be contained in the amount of 10 μg/mL. 1.3 mL of the diluted solution was introduced to 98 mL of the CDK standard preparation buffer solution for expression level to prepare a standard preparation for measuring CDK2 expression level.

### (Measurement of CDK1 and CDK2 Expression Levels)

A filter plate (MultiScreen HTS PSQ plate) was hydrophilized with 30% ethanol, and 200 μL of the TBS was introduced to each well and suctioned for cleaning. 100 μL of the respective measurement samples were introduced to each well and suctioned to remove any water content. Then, 300 μL of the TBS was introduced to each well and suctioned for cleaning, and 100 μL of the blocking reagent was introduced to each well and suctioned. After the blocking reagent was suctioned, 50 μL of the anti-CDK1 antibody reagent (primary antibody reagent) was introduced to each well and suctioned. 50 μL of the anti-CDK1 antibody reagent was introduced to each well again and left at rest at 23° C. for two hours. Then, the primary antibody reagent was removed by suctioning. Then, 300 μL of the TBS was repeatedly introduced to each well and suctioned for cleaning four times. After the cleaning, 50 μL of the secondary antibody reagent was introduced to each well and suctioned. 50 μL of the secondary antibody reagent was introduced to each well again and left at rest at 23° C. for 45 minutes. Then, the secondary antibody reagent was removed by suctioning. Then, 300 μL of the TBS was introduced to each well and suctioned for cleaning twice. After the cleaning, 100 μL of the fluorescence-labeled reagent was introduced to each well and suctioned. Then, 300 μL of the TBS was repeatedly introduced to each well and suctioned for cleaning four times. After the cleaning is done, 200 μL of the fluorescence-enhancing reagent was introduced to each well and suctioned. Then, the filter plate was dried.

After the filter plate was dried, a fluorescence intensity was measured in each well of the filter plate by Infinite F 200 (supplied by Tecan). The CDK1 and CDK2 expression levels in the respective measurement samples were calculated based on analytical curves drawn by the use of calibrators. As the calibrators were used: 300 μL and 270 μL of the standard samples for measuring BG of CDK1/2 expression levels to which 30 μL of the standard sample for measuring CDK1 expression level was introduced, 150 μL of the standard sample for measuring CDK1/2 expression level BG to which 150 μL of the standard sample for measuring CDK1 expression level was introduced, and 300 μL of the standard sample for measuring CDK1 expression level. 100 μL of these calibrators were respectively introduced to the wells of the filter plate (MultiScreen HTS Filter Plate) followed by the blocking procedure, the incubation with primary and secondary antibodies, and the incubation with the fluorescence-labeling reagent in a manner similar to the measurement of test samples. Then, fluorescence intensities of the respective samples were measured by Infinite F200 to draw the analytical curves.

The CDK2 expression level was measured according to steps similar to the measurement of the CDK1 expression level except that the anti-CDK2 antibody reagent was used as the primary antibody in place of the anti-CDK1 antibody reagent, and the standard sample for measuring BG of CDK1/2 expression level and the standard sample for measuring CDK2 expression level were used as the calibrators.

### [Measurement of CDK1 and CDK2 Activities]

### (Preparation of Reagents and Standard Preparations) 1M of Tris-HCl:

1M of Tris-HCl was prepared, which included 1M of 2-Amino-2-hydroxymethyl-1,3-propanediol and 0.1% of NaN₃ (w/v) and had the pH adjusted to 7.4 by HCl.

### Immunoprecipitation Buffer:

The following materials were introduced at the mentioned end concentrations to a solution in which 1M of Tris-HCl was diluted by 20 times: 0.1% of NP40 and 0.1% of NaN₃ (w/v) to prepare an immunoprecipitation buffer.

### 20% Protein A Beads Solution:

300 μL of protein A beads (supplied by GE Healthcare) was applied in an Eppendorf tube having the capacity of 2 mL and 900 μL of the immunoprecipitation buffer was added thereto. Then, the tube was placed upside down to mix the materials and centrifuged at 2,000 rpm for 20 seconds to remove the supernatant. The washing procedure was repeated twice. 1,080 μL of the immunoprecipitation buffer was further introduced thereto to prepare a 20% protein A beads solution.

### CDK Antibody Diluent:

The following materials were introduced at the mentioned end concentrations to a solution in which 1M of Tris-HCl was diluted by 40 times: 1M of Sucrose, 150 mM of NaCl, and 0.1% of NaN₃ (w/v) to prepare a CDK antibody diluent.

### Anti-CDK1 Antibody Reagent:

190 μL of a 10% NaN₃ solution (w/v) was introduced to 1.9 mL of the CDK antibody diluent, and 17.5 mL of the anti-CDK1 antibody (448 μg/mL) was added thereto for diluting. 840 μL of the immunoprecipitation buffer was introduced to 480 μL of the antibody diluted solution to prepare an anti-CDK1 antibody reagent.

### Anti-CDK2 Antibody Reagent:

100 μL of a 10% NaN₃ solution (w/v) was introduced to 1.6 mL of the CDK antibody diluent, and 8.3 mL of the anti-CDK2 antibody (360 μg/mL) was added to the resulting solution for diluting. 960 μL of the immunoprecipitation buffer was added to 240 μL of the diluted solution to prepare an anti-CDK2 antibody reagent.

### Immunoprecipitation Washing Buffer 1:

The following materials were introduced at the mentioned end concentrations to a solution in which 1M of Tris-HCl was diluted by 20 times: 1% of NP40 and 0.1% of NaN₃ (w/v) to prepare an immunoprecipitation washing buffer 1.

### Immunoprecipitation Washing Buffer 2:

The following materials were introduced at the mentioned end concentrations to a solution in which 1M of Tris-HCl was diluted by 20 times: 300 mM of NaCl and 0.1% of NaN₃ (w/v) to prepare an immunoprecipitation washing buffer 2.

### Immunoprecipitation Washing Buffer 3:

NaN₃ was introduced at the end concentration of 0.1% (w/v) to a solution in which 1M of Tris-HCl was diluted by 20 times to prepare an immunoprecipitation washing buffer 3.

### Kinase Reaction Reagent:

The following materials were introduced at the mentioned end concentrations to a solution in which 1M of Tris-HCl was diluted by 18.4 times: 0.1% of NaN₃ (w/v), 20 mM of MgCl₂, 2 mM of ATP-γS (supplied by CALBIOCHEM), and 0.2 mg/mL of Histone H1 (supplied by Roche) to prepare a Kinase reaction reagent.

### 2.2M of MOPS-NaOH:

2.2M of MOPS-NaOH was prepared, which included 2.2M of 3-Morpholinopropanesulfonic acid and 0.1% of NaN₃ (w/v) and had the pH adjusted to 7.4 by NaOH.

### Fluorescence-Labeling Reaction Buffer:

The following materials were introduced at the mentioned end concentrations to a solution in which 2.2M of MOPS-NaOH was diluted by 7.3 times: 5 mM of EDTA and 0.1% of NaN₃ (w/v) to prepare a fluorescence-labeling reaction buffer.

### Fluorescence-Labeled Reagent:

25 mg of 5-(Iodoacetamido) fluorescein (supplied by Molecular Probes) and 6 mL of DMSO were introduced to 116 mL of the fluorescence-labeling reaction buffer to prepare a fluorescence-labeled reagent.

### Fluorescence-Labeling Response Stop Solution:

NaN₃ was introduced at the end concentration of 0.1% (w/v) to a solution in which 2.2 M of MOPS-NaOH was diluted by 1.1 times. 2.45 g of N-Acetyl-L-Cysteine was dissolved in 498.95 mL of the resulting solution to prepare a fluorescence-labeling response stop solution.

### Tris-Buffer Physiological Salt Solution (TBS):

10×TBS (solution containing the following materials at the mentioned end concentrations: 250 mM of 2-Amino-2-hydroxymethyl-1,3-propanediol, 0.1% of NaN₃ (w/v), and 1.5 M of NaCl and having the pH adjusted to 7.4 by HCl) was diluted by 10 times to prepare TBS.

### Fluorescence-Enhancing Reagent:

NaN₃ was added at the end concentration of 0.1% (w/v) to a solution in which Blocking One (supplied by Nacalai Tesque) was diluted by 10 times to prepare a fluorescence-enhancing reagent.

### Standard Preparation Diluent for Measuring CDK1/2 Activity:

The following materials were introduced at the mentioned end concentrations to a solution in which 1M of Tris-HCl was diluted by 20 times: 810.7 mM of Sucrose, 1% of Block Ace (w/v) (Supplied by Dainippon Sumitomo Pharma Co., Ltd.), 150 mM of NaCl, 0.1% of NaN₃ (w/v), and 0.1% of NP40 to prepare a standard preparation diluent for measuring CDK1/2 activity.

### Standard Samples for Measuring CDK1/2 Activity:

The following materials were introduced at the mentioned end concentrations to the standard dilution buffer for measuring CDK1/2 activity: 3 ng/μL of Recombinant CDK1/cyclin B1, active (supplied by Millipore), and 1 ng/μL of Recombinant CDK2/cyclin E, active (supplied by Millipore) to prepare a standard preparation for measuring CDK1/2 activity.

### [Measurement of CDK1 and CDK2 Activities]

30 μL of a 20% protein A beads solution, 90 μL of an anti-CDK1 antibody diluted solution, and 30 μL of the respective measurement samples were introduced to each well of the filter plate (MultiScreen HTS Filter Plate). The resulting solution was agitated at 4° C. for 120 minutes to cause a reaction between the anti-CDK1 antibody and the CDK1 in the measurement samples. After the reaction, any water content was removed by suctioning. Next, 200 μL of the immunoprecipitation washing buffer 1 was introduced to each well, and the beads were cleaned by suctioning. Then, 200 μL of the immunoprecipitation washing buffer 2 was introduced to each well, and the beads were cleaned by suctioning. Further, 200 μL of the immunoprecipitation washing buffer 3 was introduced to each well, and the beads were cleaned by suctioning. As a result, Sepharose beads, to which the CDK1 of the respective measurement samples were bound by the presence of the anti-CDK1 antibody, were obtained on the filter plate.

50 μL of the Kinase reaction reagent was added to each well of the filter plate and agitated at 37° C. for 60 minutes to cause a reaction.

After the Kinase reaction, a reaction product was subjected to centrifugal separation at 2,000 rpm for five minutes and then collected. Then, 14 μL of the reaction product was put in each well of MicroAmp Optical 96-well Reaction Plate (supplied by Applied Biosystems). 14 μL of the fluorescence-labeled reagent was introduced to the reaction product in each well and agitated at 25° C. for 20 minutes to cause a reaction. Then, 200 μL of the fluorescence-labeling response stop solution was added to each well to stop the reaction.

100 μL of 70% ethanol was introduced to each well of the filter plate and then removed by suctioning. Then, 200 μL of the TBS was introduced to each well and suctioned for cleaning twice. 100 μL of the reaction solution in the Optical 96-well Reaction Plate after the fluorescence-labeling response stopped was introduced to each well of the filter plate, and the reaction solution was removed by suctioning. Then, 200 μL of the TBS was introduced to each well and suctioned for cleaning twice. After the cleaning, adding of 200 μL of the fluorescence-enhancing reagent to each well, and removal of the fluorescence-enhancing reagent by suctioning. This fluorescence-enhancing reaction was performed six times. Then, the filter plate was dried.

After the filter plate was dried, a fluorescence intensity was measured in each well of the filter plate by Infinite F 200 (supplied by Tecan). The CDK1 activity was calculated in the respective measurement samples based on analytical curves drawn by using the standard preparation for measuring CDK1/2 activity as a calibrator. The analytical curves were drawn as described below. 30 μL of the standard samples for measuring CDK1/2 activity diluted by ¼ times by the standard dilution buffer for measuring CDK1/2 activity, the same diluted by ½ times, and the standard samples for measuring CDK1/2 activity were introduced to each well of the filter plate (MultiScreen HTS Filter Plate) and subjected to immunoprecipitation, Kinase reaction, and fluorescence-labeling reaction in a manner similar to the measurement samples. Then, the respective fluorescence intensities were measured by Infinite F200 to draw the analytical curves.

The CDK2 activity was measured in a manner similar to the CDK1 measurement described earlier except that the anti-CDK2 antibody was used in place of the anti-CDK1 antibody.

### [Calculation of CDK1 and CDK2 Specific Activity Values]

The CDK1 and CDK2 specific activity values were calculated as follows.

A CDK1 activity (A) included in 1 μL of each of the measurement samples was calculated based on the CDK1 activity calculated from the analytical curve. A CDK1 expression level (B) included in 1 μL of each of the measurement samples was calculated based on the CDK1 expression level calculated from the analytical curve. The CDK1 specific activity value was calculated from A/B. The CDK2 specific activity value was similarly calculated.

### <Measurement of GSTπ Expression Level>

### [Preparation of Reagents for Measuring GSTπ Expression Level]

To measure the GSTπ Expression Level, the following reagents were prepared: blocking reagent, Tris-buffer physiological salt solution (TBS), primary antibody reagent, secondary antibody reagent, and fluorescence-labeled reagent.

The preparation processes of the respective reagents are described below.

### Blocking Reagent:

Block Ace (powder) (supplied by Dainippon Sumitomo Pharma Co., Ltd.) was dissolved in ultrapure water at the end concentration of 4% to prepare a blocking reagent.

### Primary Antibody Reagent:

An anti-GSTπ antibody (supplied by BD Transduction) was dissolved at the end concentration of 5 μg/mL in a blocking solution in which the blocking reagent was diluted by 10 times to prepare a primary antibody reagent.

### Tris-Buffer Physiological Salt Solution (TBS):

10×TBS (solution in which 30.28 g of 2-Amino-2-hydroxymethyl-1,3-propanediol, 87.7 g of NaCl, and 110 g of 6N HCl were dissolved in ultrapure water to be prepared in the final amount of 1 L) was diluted by 10 times to prepare TBS.

### Secondary Antibody Reagent:

The bovine serum albumin (BSA) was dissolved at the end concentration of 1% in TBS (1% BSA). The Goat Anti-Mouse IgG (H+L)-BIOT Human/Mouse (supplied by Southern Biotech) was dissolved in the obtained TBS (1% BSA) in the amount of 30 μg/mL to prepare a secondary antibody reagent.

### Fluorescence-Labeled Reagent:

The Streptavidin-FITC (supplied by Vector) was dissolved in the TBS (1% BSA) in the amount of 10 μg/mL to prepare a fluorescence-labeled reagent.

### [Measurement of GSTπ Expression Level]

A filter plate (MultiScreen HTS PSQ plate) was hydrophilized with 30% ethanol, and 10 μL of the measurement samples was introduced to each well and suctioned to remove any water content. As the measurement samples were used the samples prepared in the first obtaining process. Then, 100 μL of the blocking reagent was introduced to each well and then suctioned. After the blocking reagent was suctioned, 50 μL of the primary antibody reagent was introduced to each well and immediately suctioned. After the suctioning, 50 μL of the primary antibody reagent was introduced to each well again and incubated for two hours. Then, the primary antibody reagent was removed by suctioning. Then, 300 μL of the TBS was repeatedly added to each well and suctioned for cleaning four times. After the cleaning, 50 μL of the secondary antibody reagent was introduced to each well and immediately suctioned. After the suctioning, 50 μL of the secondary antibody reagent was introduced to each well again and incubated for one hour. Then, the secondary antibody reagent was removed by suctioning. Then, 300 μL of the TBS was introduced to each well and suctioned for cleaning twice. After the cleaning, 100 μL of the fluorescence-labeled reagent was introduced to each well and immediately suctioned. Then, 300 μL of the TBS was repeatedly added to each well and suctioned for cleaning four times, and the filter plate was dried.

After the filter plate was dried, a fluorescence intensity was measured in each well of the filter plate by Infinite F 200 (supplied by Tecan). The calculation of the GSTπ expression levels in the respective measurement samples was performed based on analytical curves drawn by the use of GSTP1 recombinant Protein (supplied by Abnova, Cat No. H00002950-P01) as a calibrator. The analytical curves were drawn as described below. The GSTP1 recombinant Protein was introduced onto the filter plate at the concentrations of 0 ng/100 uL/well, 10 ng/100 uL/well, 30 ng/100 uL/well, and 50 ng/100 uL/well followed by the blocking procedure, the incubation with primary and secondary antibodies, and the incubation with the fluorescence-labeling reagent in a manner similar to the measurement of test samples. Then, fluorescence intensities of the respective materials were measured by Infinite F200 to draw the analytical curves.

### <Calculation of Risk Score>

A risk score (RS) was calculated by the following formula based on the obtained specific activity values of CDK1 and CDK2.

F(x)=0.15/(1+Exp(−(x−1.6)×7)

G(y)=0.25/(1+Exp(−(y−1.0)×6)

RS=3000×F(x)×G(y)

x=log(CDK1 specific activity value)

y=log(CDK2 specific activity value)−log(CDK1 specific activity value)

### <Efficacy Assessment>

After the mammotome biopsy, the breast cancer patients were subjected to 12 cycles of paclitaxel administration (T) once a week, and four cycles of administration of 5-FU, epirubicin, and cyclophosphamide (FEC) by every 21 days. Then, pathological disappearance of their tumors was assessed. Any patients, for which pathological complete response (pCR) was confirmed, were identified as response cases.

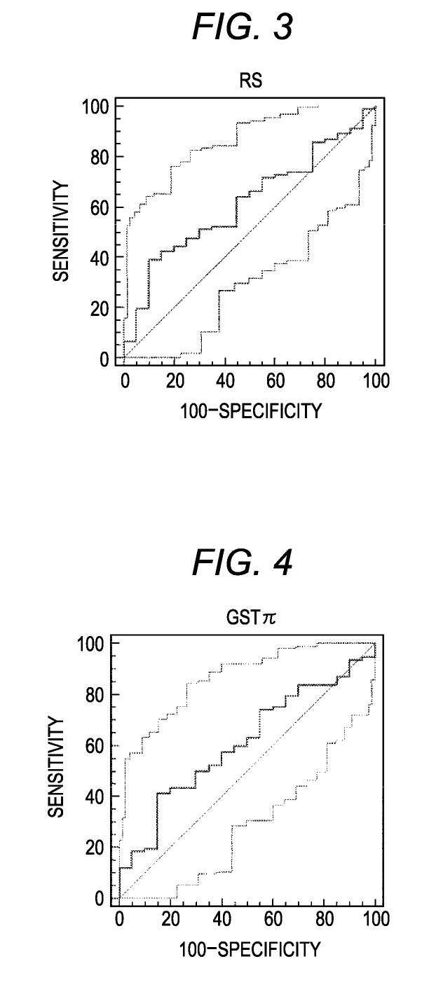

FIG. 3 illustrates an ROC curve obtained by pCR prediction subsequent to T-FEC which solely used the risk score (RS) calculated from the CDK1 and CDK2 specific activity values as an index. Referring to the illustration, AUC (Area Under the Curve) of the ROC curve=0.615, and a significance level P (area=0.5) thereof=0.1124. FIG. 4 illustrates an ROC curve obtained by pCR prediction subsequent to T-FEC which solely used the GSTπ as an index. Referring to the illustration, AUC of the ROC curve=0.608, and a significance level P (area=0.5) thereof=0.1041.

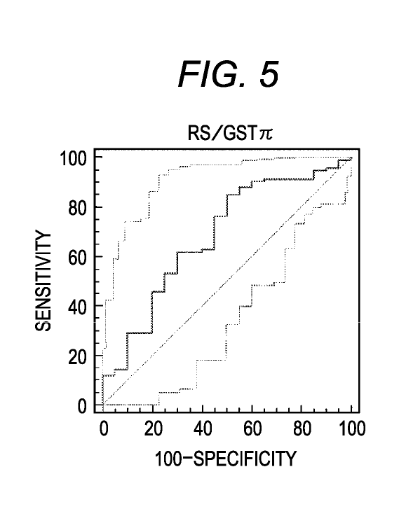

FIG. 5 illustrates an ROC curve obtained by pCR prediction subsequent to T-FEC in which the risk score and GSTπ were combined and used as an index. Referring to the illustration, AUC of the ROC curve=0.682, and a significance level P (area=0.5) thereof=0.0025. When the ROC curve of the risk score is drawn and a cut-off value of the risk score is then set, and the ROC curve of GSTπ is drawn and a cut-off value of the GSTπ is then set, a result shown in Table 3 is obtained. The cut-off value (threshold) of the risk score was set to 0.121, and the cut-off value (threshold) of the GSTπ was set to 93.1865. A positive predictive value (PPV) then=34(%), and a negative predictive value (NPV) then=93.8(%). It is indicated from the result that the combination of the risk score and GSTπ can accurately extract any patients for whom T-FEC had no efficacy, contributing to the improvement of QOL of patients by avoiding use of any carcinostatics therapeutically ineffective on them.

When the risk score and the GSTπ are combined, the AUC of the ROC curve and the P-value of the AUC both exhibited remarkable improvements as compared to when the risk score and the GSTπ are each independently used. These results teach that it is very beneficial to combine the risk score and GSTπ for pCR prediction subsequent to T-FEC.

Table 1 shows a relationship between the risk score (RS) and the GSTπ expression level (“GSTπ” in the Table) and the T-FEC efficacy.

TABLE 1

| | pCR | non-pCR | Total |
|---|---|---|---|
| RS high value and | 16 | 31 | 47 |
| GSTπ low value | | | |
| RS low value and | 4 | 61 | 65 |
| GSTπ high value | | | |
| Total | 20 | 92 | 112 |

As is known from Table 1, a significantly large number of breast cancer patients with low values of the risk score or high GSTπ expression levels resulted in non-pCR representing no T-FEC efficacy. A conclusion drawn from the result is: it is better to choose any combination chemotherapy but the T-FEC combination chemotherapy for any breast cancer patients showing low values of the risk score or high GSTπ expression levels in their biological samples collected by the mammotome. The breast cancer patients with high values of the risk score and low GSTπ expression levels showed no noticeable tendency regarding the T-FEC efficacy. The high values of the risk score are any values larger than the threshold, and the low values of the risk score are any values equal to or smaller than the threshold. The high GSTπ expression levels are larger than the threshold, and the low GSTπ expression levels are equal to or smaller than the threshold.

There is claimed:

1. A method for assessing an efficacy of combination chemotherapy, comprising:
a first obtaining process for obtaining a specific activity value of Cyclin Dependent Kinase (CDK) 1 and a specific activity value of CDK2 in a biological sample including a carcinoma cell collected from a cancer patient;
a second obtaining process for obtaining a GSTπ expression level in the biological sample; and
an assessment process for assessing the efficacy of the combination chemotherapy on the cancer patient based on the specific activity values of CDK1 and CDK2 obtained in the first obtaining process and the GSTπ expression level obtained in the second obtaining process.

2. The method according to claim 1, wherein the carcinoma cell is a carcinoma cell of breast cancer.

3. The method according to claim 1, wherein the combination chemotherapy is a combination chemotherapy in which anthracycline-series carcinostatics and taxane-series carcinostatics are combined.

4. The method according to claim 1 further comprising:
a calculation process for calculating a risk score from the specific activity values of CDK1 and CDK2 obtained in the first obtaining process using the following formula 1):
risk score=F(x)×G(y) 1)
(in the formula 1), x represents the specific activity value of CDK1, and y represents a ratio of the specific activity value of CDK2 to the specific activity value of CDK1),
wherein the assessment process assesses the efficacy of the combination chemotherapy on the cancer patient based on the risk score calculated in the calculation process and the GSTπ expression level obtained in the second obtaining process.

5. The method according to claim 4, wherein the F(x) is expressed by the following formula 2), and G(y) is expressed by the following formula 3):
F(x)=a/(1+Exp(−(x−b)×c)) 2)
G(y)=d/(1+Exp(−(y−e)×f)) 3)
(in the formulas 2) and 3), a to f are constants).

6. The method according to claim 4, wherein the assessment process compares the risk score to a first threshold, compares the GSTπ expression level to a second threshold, and assesses the efficacy of the combination chemotherapy on the cancer patient based on obtained comparison results.

7. The method according to claim 6, wherein the assessment process assesses the combination chemotherapy as having a low efficacy on the cancer patient when the risk score is equal to or smaller than the first threshold or the GSTπ expression level is larger than the second threshold.

8. A computer system adapted to assess an efficacy, comprising:
a processor; and
a memory, under control of said processor, including software instructions adapted to enable the computer system to perform operations comprising:
obtaining information of a specific activity value of Cyclin Dependent Kinase (CDK) 1 and a specific activity value of CDK2 in a biological sample including a carcinoma cell collected from a cancer patient;
obtaining information of a GSTπ expression level in the biological sample; and
assessing the efficacy of the combination chemotherapy on the cancer patient based on the obtained informations of the specific activity values of CDK1 and CDK2 and the obtained information of the GSTπ expression level.

9. The computer system according to claim 8,
wherein the operations further comprises calculating a risk score from the specific activity values of CDK1 and CDK2 using the following formula 1):
risk score=F(x)×G(y) 1)
(in the formula 1), x represents the specific activity value of CDK1, and y represents a ratio of the specific activity value of CDK2 to the specific activity value of CDK1),
wherein the assessing operation assesses the efficacy of the combination chemotherapy on the cancer patient based on the risk score and the GSTπ expression level.

10. The computer system according to claim 8, wherein the F(x) is expressed by the following formula 2), and G (y) is expressed by the following formula 3):
F(x)=a/(1+Exp(−(x−b)×c)) 2)
G(y)=d/(1+Exp(−(y−e)×f)) 3)
(in the formulas 2) and 3), a to f are constants).

11. The computer system according to claim 8, wherein the assessing operation compares the risk score to a first threshold, compares the GSTπ expression level to a second threshold, and assesses the efficacy of the combination chemotherapy on the cancer patient based on obtained comparison results.

12. The computer system according to claim 8, wherein the assessing operation assesses the combination chemotherapy as having a low efficacy on the cancer patient when the risk score is equal to or smaller than the first threshold or the GSTπ expression level is larger than the second threshold.

13. The computer system according to claim 8, wherein the operation for obtaining the informations of the specific activity values of CDK1 and CDK2 calculates the specific activity value of CDK1 from an activity value and an expression level of CDK1, calculates the specific activity value of CDK2 from an activity value and an expression level of CDK2, and obtains the calculated specific activity values of CDK1 and CDK2 as the informations of the specific activity values of CDK1 and CDK2.

14. An efficacy assessment device, comprising:
an obtaining unit for obtaining information of a specific activity value of Cyclin Dependent Kinase (CDK) 1, information of a specific activity value of CDK2, and information of a GSTπ expression level in a biological sample including a carcinoma cell collected from a cancer patient; and
an assessment unit for assessing the efficacy of the combination chemotherapy on the cancer patient based on the information of the specific activity value of CDK1, the information of the specific activity value of CDK2, and the information of the GSTπ expression level obtained by the obtaining unit.

15. The efficacy assessment device according to claim 10,
wherein the obtaining unit obtains an activity value and an expression level of CDK1 as the information of the specific activity value of CDK1, and obtains an activity value and an expression level of CDK2 as the information of the specific activity value of CDK2, and
the assessment unit calculates the specific activity value of CDK1 from the activity value and the expression level of CDK1, calculates the specific activity value of CDK2 from the activity value and the expression level of CDK2, and assesses the efficacy of the combination chemotherapy on the cancer patient based on the calculated specific activity values of CDK1 and CDK2 and the information of the GSTπ expression level.
